(19) United States
(12) Patent Application Publication
(10) Pub. No.: US 2016/0099753 A1
(43) Pub. Date: Apr. 7, 2016

(54) SYSTEM AND METHOD OF DELIVERY OF INFORMATION USING NFC

(71) Applicant: Pouch Pac Innovations, LLC, Sarasota, FL (US)

(72) Inventor: R. Charles Murray, Sarasota, FL (US)

(21) Appl. No.: 14/872,345

(22) Filed: Oct. 1, 2015

Related U.S. Application Data
(60) Provisional application No. 62/058,136, filed on Oct. 1, 2014.

(51) Int. Cl. H04B 5/00; A63F 13/31; H04L 29/08

(52) U.S. Cl. CPC H04B 5/0031; H04L 67/02; H04L 67/146; A63F 13/31

(57) ABSTRACT

A system with a portable device having an information tag such as a bar code, QR (Quick Response) code, an RFID (Radio Frequency Identification) tag and/or an NFC (Near Field Communication) tag attached thereto is provided. The system also includes a portable electronic device (PED), a communication network and a management platform. The bar code, QR code, RFID tag and/or NFC tag has, provides and directs a portable electronic device (PED) to a specific URL (Uniform Resource Locator). The specific URL links to a website, webpage and the like, which subsequently provides data, information, etc., back to the PED. In some instances, the portable device can be a gaming device and the management platform can allow a user to play a game.

### CROSS-REFERENCE TO RELATED APPLICATIONS

This application claims priority of U.S. Provisional Patent Application Ser. No. 62/058,136 filed on Oct. 1, 2014, which is incorporated in its entirety herein by reference.

### FIELD OF THE INVENTION

The instant disclosure is related to a product and/or system for delivering and/or obtaining information using NFC technology.

### BACKGROUND OF THE INVENTION

Flexible pouches are known for containing a liquid, powder material, and the like. Such pouches are also known to have bar codes, quick response (QR) Codes and/or radio frequency identification (RFID) tags attached thereto such that information on the pouch and/or material contained within the pouch are provided at a desired time. However, both bar codes and RFID tags typically require a special electronic scanner or reader to obtain such information. Therefore, a flexible pouch that can provide desired information to a portable electronic device would be desirable. A system that can provide flexible pouch and/or product information to a portable electronic device used by an individual to scan or read a bar code, QR code and/or RFID tag on a pouch would also be desirable.

### SUMMARY OF THE INVENTION

A flexible pouch having an information tag such as a bar code, QR (Quick Response) code, an RFID (Radio Frequency Identification) tag and/or an NFC (Near Field Communication) tag attached thereto is provided. The bar code, QR code, RFID tag and/or NFC tag has, provides and directs a portable electronic device (PED) to a specific URL (Uniform Resource Locator). Naturally, the specific URL links to a website, webpage and the like, which subsequently provides data, information, etc., back to the PED. It is appreciated that a PED can be a smartphone, tablet, laptop and the like, or in the alternative, any new type of PED not yet known to those skilled in the art but operable to be easily carried by an individual and communicate with a communication network such as a wireless telephone network, the internet and the like.

A system for providing the bar code, QR code, RFID tag and/or NFC tag and for providing pouch and/or product information to the PED is also provided. The system has a management platform, a brand/tag manager and a communication network that affords for an individual using the PED to interact and engage with desired content related to the pouch and/or product for a bar code, QR code, RFID tag and/or NFC tag that has been scanned or read by the PED. In addition, the system affords for businesses such as retailers, marketing companies, etc., to interact with the individual using the PED. In this manner, enhanced or “rich” pouch and/or production information can be provided to the individual using the PED.

The management platform and brand/tag manager responds to information read from the information tag and provided by the PED with at least one response. The at least one response can be a sales coupon, an advertisement, a question, a link to an electronic game, an electronic game download, a photograph, a song, and the like. In addition, the management platform provides the at least one response to the PED via the communication network. In some instances, the brand/tag manager provides the response.

The PED is operable to receive the response and generate a reply provided by a user and communicate the reply to the management platform and/or the brand/tag manager via the communication network. Upon receiving the reply, the management platform can execute an analysis thereof and modify future responses as a function of the analysis.

It is appreciated that the information tag has an antenna printed onto the flexible pouch and the antenna is printed using an information tag printer that may or may not contain or use ink that has conductive nanoparticles. In addition, a software unit, module, program, etc., can be provided which is operable to code the information tag with the at least one type of information during printing of the information tag. The software unit may or may not be located on a flexible pouch manufacturing machine and/or the information tag printer.

The NFC tag and PED can also be used with other products such as cups, bottles, cans, drinking glasses, trays and static piece gaming devices with a pull tab, scratch off film, peel-off label, etc. In this manner, the NFC tag allows an individual to obtain information on a given product and possibly enter a game or gambling event via the PED. In some instances, the cups, bottles, cans, drinking glasses, trays and static piece gaming devices with a pull tab, scratch off film, peel-off label, etc. is a gaming item and the NFC tag affords for a user of the PED to play a game.

### BRIEF DESCRIPTION OF THE DRAWINGS

FIG. 1 is a schematic illustration of a flexible pouch having a QR code, an RFID tag and/or an NFC tag according to an aspect disclosed herein;

FIG. 2 is a schematic illustration of a portable electronic device (PED) that is scanning, reading, and/or imaging the QR code shown in FIG. 1;

FIG. 3 is a schematic illustration of the PED shown in FIG. 2 having an RFID and/or NFC tag reader that has been activated and is sending a signal to the RFID tag and/or NFC tag shown in FIG. 1;

FIG. 4 is a schematic illustration of the RFID tag and/or NFC tag shown in FIG. 3 communicating or transmitting a signal to the PED;

FIG. 5 is a schematic illustration of another flexible pouch having a bar code, QR code, RFID tag and/or NFC tag according to an aspect disclosed herein;

FIG. 6 is a schematic illustration of yet another flexible pouch having a bar code, QR code, RFID tag and/or NFC tag according to an aspect disclosed herein;

FIG. 7 is a schematic illustration of a system that receives and/or provides information or data to a PED according to an aspect disclosed herein;

FIG. 8 is a schematic illustration of various PED components used according to an aspect disclosed herein;

FIG. 9 is a schematic illustration of a management platform according to an aspect disclosed herein;

FIG. 10 is a schematic illustration of a system that prints an information tag on a flexible pouch according to an aspect disclosed herein;

FIG. 11 is a schematic illustration of a PROCESS according to an aspect disclosed herein; and

FIG. 12 is a schematic illustration of a system according to an aspect disclosed herein.

### DETAILED DESCRIPTION OF THE INVENTION

A flexible pouch having an information tag such as a QR code, an RFID tag, and/or an NFC tag attached thereto is provided. In addition, a system that affords for scanning/reading of the QR code, RFID tag, and/or NFC tag is included, the system also being operable to receive pouch and/or product information from the information tag and provide a response to the information.

The system includes a PED, a communication network, a management platform, and a brand/tag manager. In combination with the information tag associated with a particular flexible pouch, the system can provide specific information as a function of location of the pouch, a product contained within the pouch, and the pouch itself. In some instances, the information tag is an NFC tag, and the NFC tag can in fact be an RFID tag, a modified RFID tag and the like.

In one aspect, the PED is used to scan or read a QR code on a flexible pouch container, the QR code providing a URL to the PED which subsequently connects with a website or webpage associated with the URL. In this manner, information such as advertising, discount coupons, etc. for the flexible pouch and/or a product contained within the flexible pouch which the QR code is attached thereto can be provided to an individual that has the PED, e.g. a PED.

In another aspect, the PED can communicate with an RFID and/or NFC tag which directs the PED to a management platform. For the purposes of instant disclosure, the term management platform refers to a software and/or hardware system that receives and sends information related to a scanned or read RFID and/or NFC tag. Upon receiving contact from the PED, the management platform provides product and/or pouch information back thereto. In some instances, the PED communicates a current geographical location and/or a preferred language to the management platform. Then in return, the management platform provides information related to the location and/or preferred language back to the PED. For example, if the location is determined to be a retail location, e.g. a clothing store, a grocery store, restaurant, etc., the management platform can provide information such as a discount coupon, recipes, other products to be purchased with the given flexible pouch and the like. In the alternative, if the location is determined to not be a retail location, e.g. a residence for an individual, the management platform realizing that the flexible pouch is at a residence can provide cooking instructions, storage instructions, etc., for a product within the flexible pouch.

Regarding a preferred language, if the language of use for the PED is English, Spanish, French, etc., then information or data from the management platform can be provided back to the PED in English, Spanish, French, etc., respectively.

The system can also provide a response to the PED based on past, present and/or continuing evaluation of actions or selections received by the management platform. For example and for illustrative purposes only—and in response to receiving a URL from a PED that has scanned or read a bar code, QR code, RFID tag and/or NFC tag—the management platform can provide at least two responses, e.g. two choices, for an individual using the PED to select from. In addition, based on a past, present and/or ongoing analysis of selections by a plurality of individuals that have scanned similar pouches providing the same URL, the system can provide only one of the choices to the PED. In the alternative, the system can alter the order of presenting the choices to the PED. In another alternative, the system can provide additional choices to the PED. The choice(s) provided to the PED can also be determined by one or more events, locations, etc. that may affect an individual's purchasing behavior.

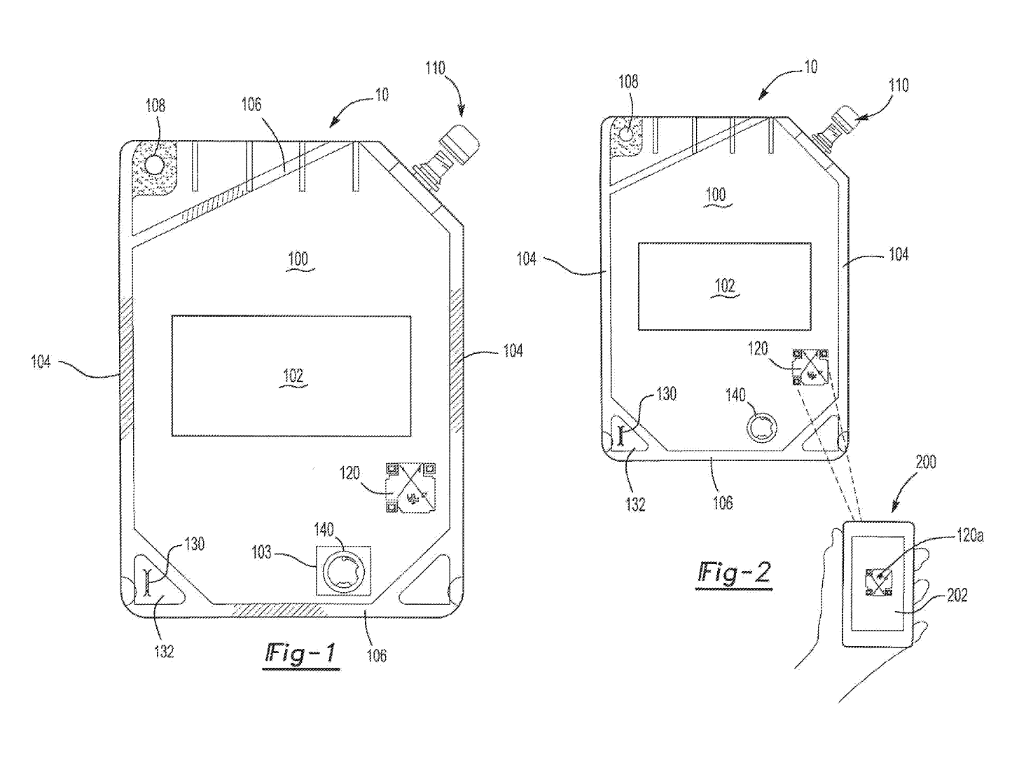

Turning now to FIG. 1, one example of a pouch according to an aspect disclosed herein is shown generally at reference numeral 10. The pouch 10 can have a side panel 100, at least one side seam 104, and one or more end seams 106. The pouch may or may not have a label 102, an aperture 108 for hanging the pouch, and/or a fitment 110 for removal of a product contained within the pouch 10.

The pouch 10 has a bar code (not shown), QR code 120, RFID tag 130 and/or NFC tag 140. The RFID tag 130 and/or NFC tag 140 can be attached to a surface of the pouch 10 and may or not be laminated, i.e. be located between a side panel 100 and an overlying laminate layer. In the alternative, the RFID tag 130 and/or NFC tag 140 can be attached or printed to the side panel 100 using an adhesive or ink, or placed and located within the pouch 10. It is appreciated that the RFID tag 130 and/or NFC tag 140 can be located within an air pocket 132, the air pocket 132 affording better reception to and transmission from the RFID tag 130 and/or NFC tag 140. In addition, if the RFID tag 130 and/or NFC tag 140 is printed and/or placed onto a flexible pouch having a foil layer that is at least part of the side panel 100, an insulating layer 103 can be present between the RFID tag 130 and/or NFC tag 140 and the side panel 100. In this manner, the tag can be insulated from the foil layer and improved communication with the tag is afforded. Also, the insulating layer 103 can be made from any insulting material known to those skilled in the art, illustratively including an electrically insulting tape layer, electrically insulting paint layer, electrically insulting paper layer and/or electrically insulting polymer layer.

In addition to the above, an antenna of the RFID tag 130 and/or NFC tag 140 is printed on the pouch 10 using an ink with nanoparticles. The shape of the antenna may or may not be in the form of a plurality of concentric circles as illustrated by the general shape of the NFC tag 140 in FIG. 1. After the printer has finished printing the antenna, the last printed portion of the antenna can still be “wet”, i.e. not yet completely solid, and a microchip is placed onto the ink with an electrical connection thus made. In some instances, the newly placed microchip is exposed to a flash of light to enhance drying of the ink and reaction of the ink with the microchip to produce a fused metal contact therebetween and thereby afford for the microchip to send and/or receive signals via the antenna.

In the alternative, the printing, placing of the microchip and optional flashing of light described above can be performed on a separate material, e.g. a sheet of paper, plastic, etc., which is subsequently attached or placed within the flexible pouch 10.

In some instances, a chipless or IC-less NFC tag as is known to those skilled in the art is printed onto and/or placed within the flexible pouch 10. The chipless or IC-less tag can be printed with printed dopant layers and materials such as disclosed in U.S. Pat. Nos. 7,767,520; 7,977,240; 8,066,805; 8,191,018; 8,227,320; and 8,304,780, all of which are incorporated herein in their entirety by reference.

Turning now to FIG. 2, a PED 200 having a screen 202 and a QR code reader 120a scans or reads the QR code 120 as is known to those skilled in the art. For example, applications can be downloaded or installed onto the PED 200 that afford for scanning and recognizing QR codes. Also, QR codes can provide information such as a website address (URL) to the PED and the PED can then be directed to the website, webpage, etc. associated with the particular URL provided by the QR code.

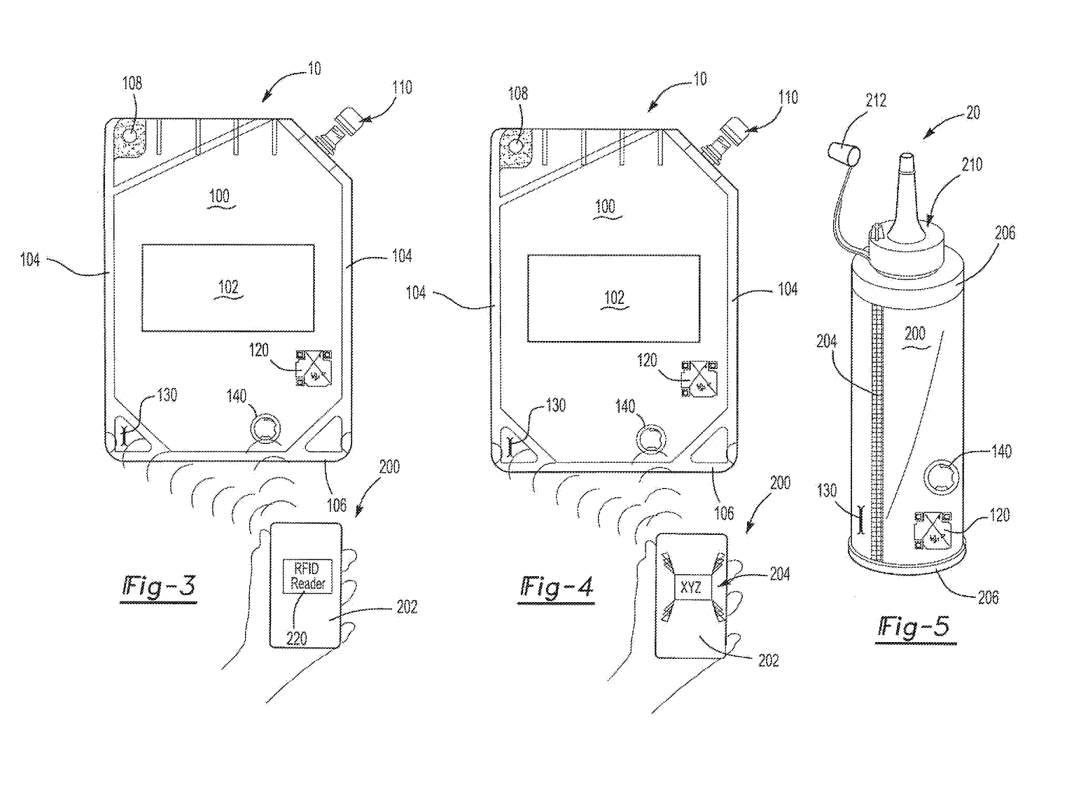

In the alternative, FIG. 3 illustrates the PED 200 with an RFID and/or NFC tag reader 220 (hereafter referred to simply as a “reader”) transmitting a signal to the RFID tag 130 and/or that NFC tag 140. For example, if the RFID tag 130 and/or NFC tag 140 is a passive RFID tag and/or passive NFC tag, then a signal from the reader 220 is required. However it is appreciated that if the RFID tag 130 and/or NFC tag 140 is an active tag, then the reader 220 can simply receive a signal from the RFID or NFC tag, i.e. a signal from the reader 220 is not required.

Assuming the RFID tag 130 and/or NFC tag 140 is a passive tag, and upon activation of the RFID tag 130 and/or NFC tag 140 by the signal from the RFID reader and/or NFC chip 220, the RFID tag 130 and/or NFC tag 140 provides a signal to the reader 220 as illustrated in FIG. 4, which may or may not be converted and/or displayed as information 204 on the screen 202. For example, the information 204 can be in the form of specific URL and/or a specific URL plus tag identifier associated with the pouch 10. In the alternative, information 204 can include any kind of information related to the flexible pouch 10 and/or material contained within the pouch 10 as is known to those skilled in the art. For example and for illustrative purposes only, the signal from the RFID tag 130 and/or NFC tag 140 can provide information such as an expiration date of material contained within the pouch 10; nutritional information such as calories, grams of protein, grams of carbohydrate, grams of fat, etc. for a product contained within the pouch; marketing information on material contained within the pouch 10; marketing information on the pouch itself; age restrictions on individuals that may or may not purchase the product; product recall notice information; medication dosage information, medication indications/contraindications information; and the like. It is appreciated that the term indication refers to a valid reason to use a certain medical test or medication and the term contraindication refers to a condition or factor that serves as a reason to withhold a certain test or medication.

In this manner, a customer or an employee at a given location can obtain desired information on a particular flexible pouch and its contents.

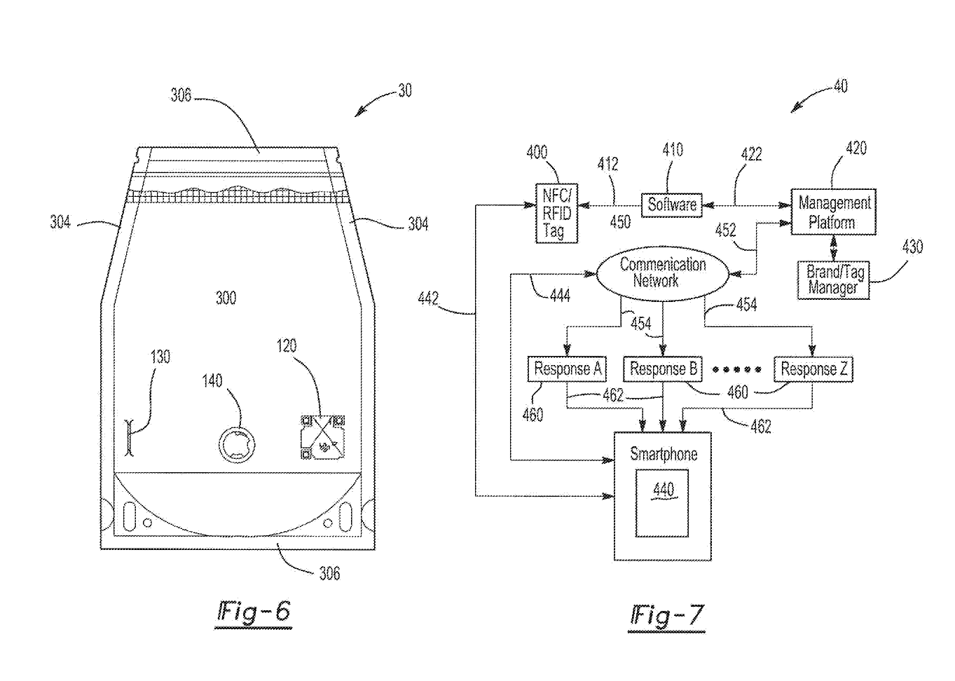

Other examples of flexible pouches that contain a bar code (not shown), QR code 120, RFID tag 130 and/or NFC tag 140 are shown in FIGS. 5 and 6 at reference numerals 20 and 30, respectively. As shown in FIGS. 5 and 6, a flexible container 200 and/or 300 designed to hold or contain condiments, juices, cereals, adhesives, candy, medical supplies, medication supplies and the like can be included.

The flexible container/pouch can be made from any material known to those skilled in the art such as sheet layer material typically used for flexible pouch manufacture. In addition, the bar code, QR code, RFID tag and/or NFC can be printed onto the surface of the sheet layer material, taped onto the sheet layer material, glued onto the sheet layer material and/or placed within the pouch.

Turning now to FIG. 7, an example of a system to provide information related to a flexible pouch and/or product contained within a flexible pouch is shown generally at reference numeral 40. The system 40 includes an NFC and/or RFID tag 400 associated with a flexible pouch (not shown). The tag 400 can be attached to the flexible pouch, contained within the pouch and the like. In some instances, the tag 400 can be printed onto an inner or outer surface of the pouch.

A software module 410 can be included, the software module 410 operable to code the tag 400. For the purposes of the instant disclosure, the term “software module” refers a software program that encapsulates related functions together for the purpose of encoding an NFC tag with desired data. In some instances, the software module 410 codes a plurality of tags “on the fly”, i.e. during the manufacture of tags and/or placement of the tags on or in respective pouches. The tags 400 can be coded to contain or have with various types of information such as a URL, a unique identifier for each pouch, a unique identifier for a plurality of pouches fabricated within a given time period and/or date, time and date of manufacture of a pouch, contents within a pouch, a manufacturer of the pouch and/or product contained within the pouch, a product supplier for material used to fabricate the pouch, and the like. In addition, environmental factors associated with the pouch, product contained in the pouch, date and time related to the manufacture of the pouch, date and time product was placed into the pouch, and the like can be coded into or on the tag(s) 400.

The software module 410 can be located on a flexible pouch manufacturing machine (not shown), an RFID and/or NFC tag printer (not shown) and the like. In addition, the software module 410 can be part of an electronic control unit (ECU) and can receive data from any number of sources, illustratively including a flexible pouch manufacturing machine, an RFID and/or NFC tag printer, a pouch material supplier, a supplier of product contained or to be contained within a flexible pouch and the like. Based on the data received from a particular source, the software module 410 can code the RFID and/or NFC tags as a function thereof.

The software module 410 can also be in communication with a management platform 420 which is in communication with a brand/tag manager 430. In this manner, data can be provided to the software module 410, e.g. before coding of a plurality of tags 400, and/or the software module 410 can provide data to the management platform and/or brand/tag manager 430, e.g. after coding of a plurality of tags. The NFC and/or RFID tag 400 can be coded via link 412 and the software 410 is in communication with the management platform 420 via link 422. Finally, the management platform 420 is in communication with the brand/tag manager 430 via link 432.

The tag 400 can be encoded with data or information as described above, e.g. with a URL that directs a PED 440 to the management platform 420. In particular, the PED 440 can read the tag 400 using NFC communication as is known to those skilled in the art. Such communication is commonly referred to as “tapping” or being “tapped”. Upon tapping the tag 400 with the PED 440 via link 442, a unique URL can appear on the PED 440 via NFC software and components inherent and/or included within the PED 440. The URL is then directed from the PED 440 through a communication network 450 to the management platform 420 via links 444 and 452, respectively.

Upon receiving the unique URL, the management platform 420 recognizes the unique URL code and allocates a predetermined response designed by the brand/tag manager 430 via link 432. In addition, the brand/tag manager 430 can provide response data or information back to the PED 440 via link 432, management platform 420, link 452, communication network 450 and link 444. The data or information from the brand/tag manager 430 can be preassigned responses in the form of a webpage or web application such that a coupon, question, game, survey, photo, and the like is provided to the user operating the PED 440. In some instances, audio can be included with one or more responses.

It is appreciated that the user of the PED 440 can interact with the received data or information, such interaction being transmitted back to the management platform 420 to be analyzed, responded to, stored for later analysis, etc. For example and for illustrative purposes only, FIG. 7 illustrates a series of responses 460 that can be transmitted to the PED 440 via links 462. The responses labeled Response A, Response B, . . . Response Z can originate from the management platform 420 and/or brand/tag manager 430, and be submitted in response to information or data obtained from the NFC and/or RFID tag 400 by the PED 440 and communicated to the management platform 420 via the communication network 450. A user of the PED 440 can select a particular response, e.g. Response B, which affords continued interaction between the user and the system 40. For example and for illustrative purposes only, selection of Response A triggers the management platform 420 and brand/tag manager 430 to deliver a coupon back to the PED 440. Other responses from the management platform 420 and brand/tag manager 430 can include one or more questions delivered to the PED 440, an electronic game or a link to an electronic game to the PED 440, a survey to be completed by the user of the PED 440, a photo, a song, and the like.

The system 40 also affords for analysis of selections to one or more of the responses 460. For example, a plurality of similar coded tags 400 can be scanned by a plurality of PEDs, e.g. by individuals purchasing flexible pouches having a tag 400. In response to the tags 400 being scanned, at least a subset of individuals respond or select one of the responses 460 provided to their PED. In addition, the management platform 420 can store and/or analyze the selections and in return provide only the responses 460 to future users that tap a similar coded NFC and/or RFID tag 400.

The responses 460 can be related to a specific location and/or event that one or more users with the PED(s) 440 are located at and/or participating in. For example, if the user of the PED 440 is at a sporting event and purchases a flexible pouch having the tag 400, a response 460 provided by the management platform 420 and brand tag manager 430 can be specifically oriented or associated with the sporting event. Again, for example and illustrative purposes only, upon tapping of a flexible pouch having a tag 400, the PED 440 can direct a URL of the tag and a GPS location of the PED to the management platform 420. Based on the GPS location, and possibly a date and time of the tapping event, the management platform 420 can determine that the PED and thus the individual are at a known sporting event. Furthermore, the tag 400 can transmit data or information that informs the management platform 420 that a flexible pouch with alcoholic beverage therewithin has been or may be purchased. Finally, such information can be used by the management platform 420 and the brand/tag manager 430 to provide a response 460 in the form of an advertisement for a local entertainment facility such as a bar, restaurant and the like.

The system 40 can also afford for an advertisement and/or opportunity for the user of the PED 440 to purchase an item associated with the sporting event such as a cap, jersey, etc., at the sporting facility and/or online, e.g. over the internet. It should be appreciated that anything on a webpage or web application can be provided to the PED 440 as a result of the phone tapping the tag 400.

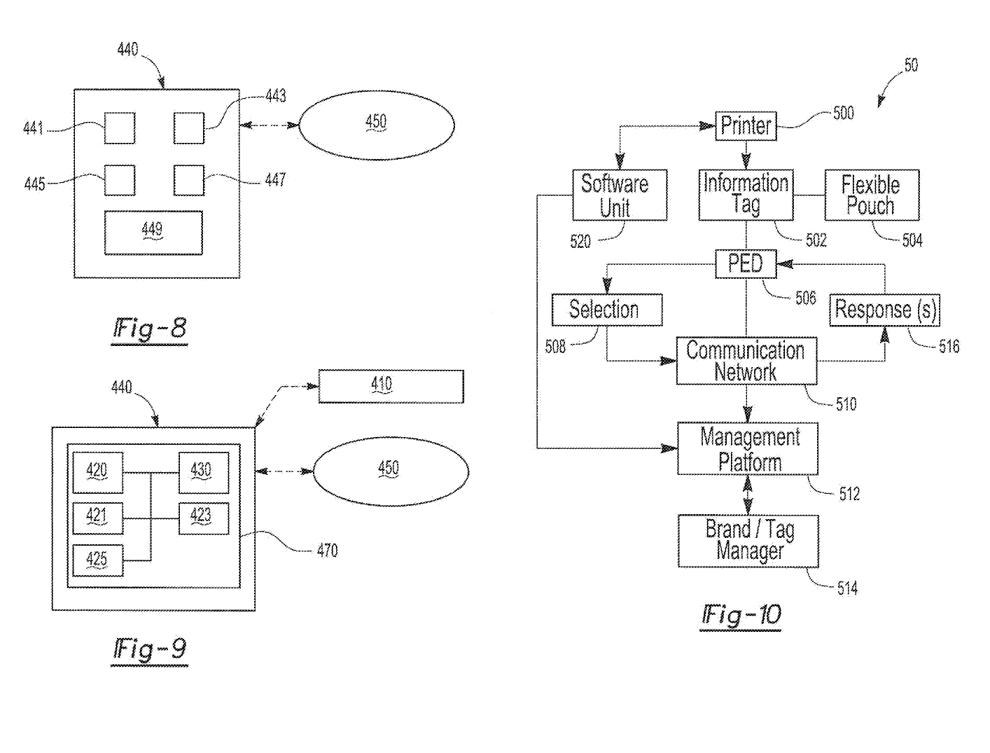

The PED 440 can have one or more components as illustrated in FIG. 8. For example, the PED 440 can have a bar code scanner/reader 441, a QR code scanner or reader 443, an RFID tag reader or scanner 445, and/or an NFC tag scanner or reader 447. In addition, the PED 440 can have a software module 449 that communicates with the components 441-447 and directs communication with the communication network 450, management platform 420, and/or brand/tag manager 430.

The management platform 420 can be located on a computer 460 which has a processing unit 470 as illustrated in FIG. 9. The processing unit 470 can include some or all of the management platform 420 and/or the brand/tag manager 430. In some instances, the brand/tag manager 430 is contained in a separate computer, however this is not required. The computer 460, processing unit 470 and/or management platform 420 can include memory 421, a processing unit software module 423, and a communication module 425 that are in electronic communication with each other. Also the management platform 420 communicates with the communication network 450 and the software 410.

The software module 410 can code the tag 400 in real time, i.e. as the tags are being produced and/or placed within and/or attached to a flexible pouch container. The software module 410 can communicate with the management platform 420 and/or brand/tag manager 430 and thus provide data on how many tags 400 have been produced, a product contained within a flexible pouch associated with the tags 400, and the like. In this manner, two-way communication between the software module 410 and the brand/tag manager 430 can be obtained.

The system 40 affords for a number of advantages over current art systems. For example and for illustrative purposes only, the system 40 provides a unique numbering system to identify the tags 400; allows for language detection for choice of media/data provided to the PED 440; coupon distribution and/or other brand loyalty actions/responses; analysis of customer responses to data provided to the PED 440; ability for brand protection to reduce counterfeiting through the use of unique code URLs/IDs; tracking the number of clicks from one or more PEDs 440 associated with a particular product; tracking of the number of tags and/or flexible pouches associated with particular tags in the marketplace; added value in the marketplace in the form of software as a service (SAAS); custom analytics and reporting directly to the brand manager's website; mobile landing page generator that may or may not be multilingual; publishing and unpublishing of the tags 400; setting of timing for broadcast frequency and type; bilateral communication between the product/production machinery to the management platform 420; generating and writing of tags 400 while in communication with the management platform 420; and mass coding of tags during assembly line production of the labeling, embedding, placing, and/or printing of the tags 400.

In this manner, a system is provided for enhancing the marketability, sales, and user enjoyment of specific and desired flexible pouches. It should be appreciated that data provided to the PED 440 in the form of a webpage, text, tweet, and the like can include health information; calories; ingredients; how to use or open a flexible pouch; how not to use a flexible pouch; a list of complementary items/products; whether or not the product is organic; the place of origin of the product; related nonprofit/charity organizations associated with the product; a percentage of sale of the product to be donated to a nonprofit/charity organization; links to other products such as movies, documentaries, music videos, music, and the like; links to Twitter accounts; links to Facebook accounts; and links to other apps. In addition, the information/data provided to the PED 440 promotes interaction of a user of the PED with the management platform 420 and brand/tag manager 430, thereby engaging the user and enhancing sales of products associated with the tags 400.

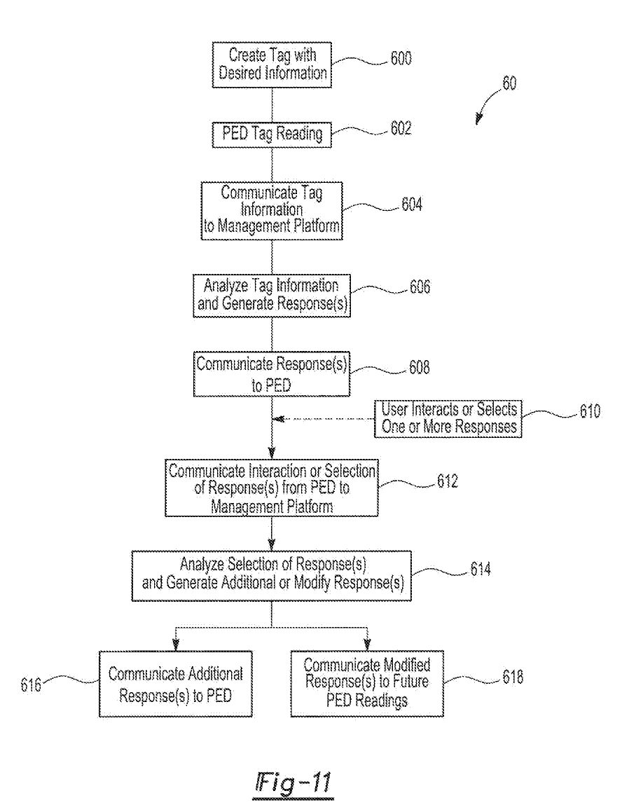

Turning now to FIG. 10, another example of the system is shown generally at reference numeral 50. The system 50 includes an information tag printer 500 that is operable to print an information tag 502 onto a flexible pouch 504. In addition, the information tag is operable to receive and/or send information to a PED 506. A user of the PED 506 can make a selection 508 in response to the signal from the information tag 502 and the selection is communicated to a management platform 512 via a communication network 510. For the purposes of the instant disclosure, the term communication network is defined as a collection of terminal nodes with links connected to the terminal nodes so as to enable telecommunication between the terminals. Illustrative examples of a communication network include the internet, a cellular network or mobile network where one or more links, e.g. the last link is wireless, and an intranet network within a facility, company, corporation and the like.

The selection may or may not be communicated to the brand/tag manager 514 and a response 516 is communicated via the communication network back to the PED 506. In this manner, the management platform 512 and/or brand/tag manager 514 can provide a customized response after viewing or analyzing the selection 508. In addition, based on the selections and/or responses, the management platform 512 can be in communication with a software unit 520 that is in communication with the printer 500 and be used to code future information tags 502.

Referring to FIG. 11, a process according to an aspect disclosed herein is shown generally at reference numeral 60. The process 60 includes creating a tag with desired information at step 600 and reading the tag with a PED at step 602. The information read from the tag at step 602 is communicated with a management platform at step 604. The tag information is analyzed and one or more responses is generated at step 606. The response or responses are communicated to the PED at step 608 and a user may or may not interact or select one or more of the responses at step 610. The interaction or selection of the one or more responses from the PED is communicated back to the management platform at step 612. The management platform analyzes the selection of the one or more responses and generates additional responses and/or modifies future responses at step 614. At step 616 an additional one or more responses is communicated back to the PED, while at step 618 one or more modified responses are generated by the management platform to be used at step 608 in the future. This cycle can be repeated such that continued interaction and analysis of responses provided by one or more users of the PED are analyzed and used to provide desired information to the users, and also provide valuable marketing information to businesses, retailers and the like.

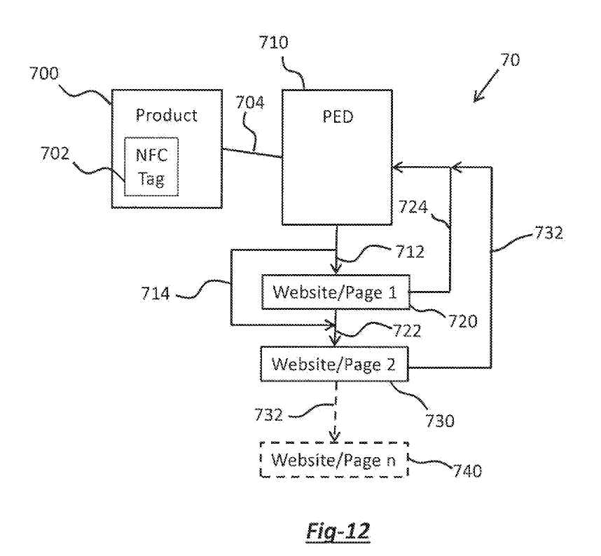

Another aspect disclosed herein is schematically shown in FIG. 12 at reference numeral 70. The aspect 70 includes a product 700 with an NFC tag 702. The product can be any product that has an NFC tag attached thereto or included therein, illustratively including a game item in the form of a flexible pouch, cup, bottle, can, glass, tray and static piece gaming devices with a pull tab, scratch off film, peel-off label, etc. It is appreciated that the pouch, cup, bottle, can, glass, tray, etc., can be used to hold a beverage drink, snack, and the like. In addition, the flexible pouch, cup, bottle, can, glass, tray and static piece gaming devices with the pull tab, scratch off film, peel-off label, etc. can be a gaming item and the associated NFC tag 702 transmits data in the form of a request to a user of a PED 710 to play a game.

The NFC tag 702 is scanned or read by the PED 710 such as a smartphone. Thereafter the PED 710 is directed to a website 1 and/or website page 1 via communication line 712 where product information 720 on the product 700 is obtained. In addition, the product information 720 is delivered back to the PED 710 via communication line 724. It is appreciated that the product information 720 can be in the form of a coupon, reward points, expiration date of the product, nutritional information of the product, marketing information on the product, age restrictions on individuals that may or may not purchase the product, product recall notice information and the like. For the purposes of the instant disclosure, the term “communication line” refers to both wired and wireless communication systems and signals as is known to those skilled in the art.

After receiving the product information 720, the PED can then be directed to a website 2 and/or website page 2 730 via communication line 722 where additional information is provided to the PED 710 via communication line 732. The additional information can be in the form of gaming or gambling information such as a chance to play a lottery, card game, etc. In some instances, the website 2 and/or website page 2 requires an individual to provide registration information before proceeding to the gaming or gambling information. Such registration information can include but not be limited to the individual's name, age, sex, home address, credit card information and the like. Once the individual has entered the appropriate registration information, if required, the website 2 and/or website page 2 can interact with the individual via the PED such that the individual has a chance to win a game or gambling event.

In some instances, the PED can go directly to the website 2 and/or website page 2 730 via communication link 714, and thereby receive the additional information discussed above without being directed to the website 1 and/or website page 1 720.

In order to better provide a teaching of one or more aspects disclosed herein, but not limit the scope of the instant disclosure in any way, the following examples are provided.

In one example, an individual with the PED 710, e.g. a smartphone, is at an entertainment event such as a sporting event, a casino, a horse race, etc., and purchases or is given a beverage. The beverage is in a container 700 such as a flexible pouch, cup, can, bottle, glass, etc. The container 700 has an NFC tag 702 associated therewith and which can be read or scanned by the PED 710. The individual scans or reads the NFC tag 702 with the PED 710 and the PED 710 is directed to the website 1 and/or website page 1 720, which in turn provides product information on the beverage. The website 1 and/or website page 1 720 also provides an option to the individual to play a game, e.g. a pick 3 instant lottery game.

If selected by the individual, the website 1 and/or website page 1 720 directs the PED 710 to the website 2 and/or website page 2 730 where a request for registration information from the individual is delivered. Upon entry of the appropriate registration information, the website 2 and/or website page 2 730 allows the individual to select 3 lottery numbers, or in the alternative, automatically selects 3 lottery numbers for the individual. In addition, the 3 lottery numbers are compared to a winning set of 3 lottery numbers and the individual is informed via the PED 710 as to whether or not he/she has won. It is appreciated that the individual can even be awarded a secondary prize, e.g. a free beverage, a food item, etc., if he/she wins or does not win the lottery game.

In the event that the individual has won the lottery game, payment information provided by the individual can be used to transfer money back to a credit card, debit card, etc., or in the alternative, the individual could receive his/her winnings at a cashier's desk. It is appreciated that the website 2 and/or website page 2 720 can allow for the individual to continue playing one or more games. In addition, the PED 710 can be directed to additional websites and/or website pages n as illustrated by the dotted line arrow 732 and dotted line box 740 in FIG. 12.

In another example, an individual obtains a gaming device or product 700 such as a scratch off ticket/card, pull tab ticket/card, peel and reveal ticket/card, etc. Upon scratching off a film, pulling a tab and/or peeling a sticker from the ticket/card, the individual instantly has knowledge as to whether or not he/she has won a gambling event. Thereafter, the individual enters a “second chance to win” by scanning an NFC tag 702 that is attached and/or is part of the gaming device or product 700 using a PED 710. Upon scanning the NFC tag 702, the PED 710 is directed to the website 1 and/or website page 1 720, as discussed above, which in turn directs the PED and the individual to the website 2 and/or website page 2 730 as discussed above. In the alternative, the PED is directed straight to the website 2 and/or website page 2 730. In this manner, the individual can have a second chance to win a prize, money, etc., even if he/she did not win initially.

In yet another example, an individual or user obtains a game item 700 with an NFC tag 702. The user has a PED 710 that is communicatively coupled to a communication network, e.g. communication network 510 as shown in FIG. 10. The communication network 510 is also communicatively coupled to a management platform, e.g. management platform 512 shown in FIG. 10, and optionally communicatively coupled a brand/tag manager, e.g. brand/tag manager 514 shown in FIG. 10. The NFC tag 702 has and is configured to transmit data to the PED 710 and the PED is configured to receive the data from the NFC tag 702. In some instances, the data is a request to the user to play a game and may or may not include a URL address which can direct the PED to a website that provides the request to the user, e.g. using a display screen of the PED.

The PED 710 is configured to accept a response from the user and transmit the response to the management platform and/or brand/tag manager. The response by the user can be the result of an interaction with the PED 710 by the user which provides an analog or digital signal to a processor of the PED 710. In some instances, the interaction is the user touching the display screen of the PED 710 in order to select one or more options on the display screen. In other instances, the interaction is the user clicking a mouse on the display screen of the PED 710 in order to select one or more options on the display screen. In still other instances, the interaction is the user giving a voice command to the PED 710 in order to select one or more options.

The management platform and/or brand/tag manager is configured to receive the response from the user and transmit a result to the PED 710. Then, the PED 710 is configured to transmit the result to the user, e.g. providing a visual result using the display screen of the PED 710, an audio result using a speaker of the PED 710, and the like. The result can inform the user if one or more games, or one or more trials of a single game has been won, lost, tied, etc. For example, the result can be “You-Won” which instructs the user that his/her response has resulted in a winning selection, answer, etc. In the alternative, the result can be “You-Lost” which instructs the user that his/her response has resulted in a losing selection, answer, etc. In still another alternative, the response can be “You-Won-Play-Again?” or “You-Lost-Play-Again?” which instructs the user that his/her response has resulted in a winning or losing selection, answer, etc., respectively, and that asking if the user would like to play again. It is appreciated that the exact wording and language of the response is not restricted to the examples shown above so long as the general meaning of the responses is provided to the user. In addition, other responses to playing a game as is known to those skilled in the art can be provided.

The management platform and/or brand/tag manager is configured to provide at least one option to the user that allows the user to play another game; play a different game; purchase an item using winnings, points, etc., resulting from one or more games that have been played; and/or purchase an item using a credit card, credit account, etc.

In addition to the above, the individual can also get access to a wide range of social media applications as well as access to various audio and visual media applications. Also, game cards can become talking game pieces. Furthermore, non-for-profit organizations such as the Red Cross, FEMA, etc., can use the game cards for fundraising purposes, linking the consumer to local causes and the like.

The invention is not to be limited to the described examples and aspects herein. Changes, modifications and the like can be made by those skilled in the art and still fall within the scope of the instant disclosure. As such, it is the claims, and all equivalents thereof, that define the scope of the disclosure.

I claim:

1. A system for delivering information using NFC comprising:
a game item having an NFC tag;
a PED;
a communication network communicatively coupled to said PED; and
a management platform communicatively coupled to said communication network;
said NFC tag configured to transmit data to said PED, said data being a request to a user of said PED to play a game;
said PED configured to receive said data, accept a response to said request from the user and transmit said response to said management platform via said communication network;
said management platform configured to receive said response via said communication network and transmit a result to said PED via said communication network, said PED configured to receive said result from said management platform and display said result to the user of the PED, said result being at least one of You-Won, You-Lost, You-Won-Play-Again? and You-Lost-Play-Again?.

2. The system of claim 1, wherein said data is a URL address and said PED is configured to connect to said URL address via said communication network and said URL address is a website with said request to the user of said PED to lay said game.

3. The system of claim 2, wherein said response from the user is an interaction with the PED by the user, the interaction being at least one of touching a display screen of said PED, clicking a mouse on said display screen, and giving a voice command to said PED.

4. The system of claim 3, further comprising said management platform configured to transmit at least one option to said PED in addition to said result.

5. The system of claim 4, wherein said at least one option is at least one of Play-Another-Game?, Purchase-An-Item-With-Winnings?, and Purchase-An-Item?
